(19) United States
(12) Patent Application Publication
(10) Pub. No.: US 2006/0264096 A1
(43) Pub. Date: Nov. 23, 2006

(54) Surface mount retention module

(76) Inventor: Kenneth William Johnson, Colorado Springs, CO (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/130,784

(22) Filed: May 17, 2005

(51) Int. Cl. H01R 13/73

(52) U.S. Cl. 439/566

(57) ABSTRACT

A retention module includes alignment features. The retention module is adapted for surface mounting over a circuit board or other structure.

### BACKGROUND

Measurement and testing of an electronic device often includes a probe assembly that connects to dedicated pads on a circuit board of the device under test (often referred to as the target). More recently, the connection of the probe to the circuit board of the target (target board) does not include the use of a dedicated electrical connector. This type of probing is often referred to as ‘connectorless’ probing.

Connectorless probing often includes a retention module, which is adapted to receive the probe assembly in an opening in the module. In addition to providing retention and strain relief of the probe assembly, the retention module fosters alignment of the individual probes of the probe assembly to respective pads on the circuit board.

While clearly advantageous over probing via dedicated connectors, known connectorless probing has certain drawbacks. For example, known retention modules are fastened using screws that extend through the target board. This requires fabricating holes in the boards for the screws as well as access to both sides of the board to assemble the retention module to the board. The need to access both sides of the board is extremely cumbersome. The typical process of fastening known retention modules requires maintaining the retention module in place while the board is rotated to access the opposite side. Moreover, the retention module is maintained in place during the fastening of the screws.

In addition to the rather labor intensive manufacturing described, the holes for screws take up valuable space on the target board. In addition, the holes through the target board interfere with inter-layer circuit lines (often referred to as routing lanes) of the multi-layer target board.

What is needed, therefore, is an interface for a probe assembly and a retention module that overcome at least the shortcomings described above.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A is a perspective view of a retention module disposed over a printed circuit board in accordance with an example embodiment.

FIG. 1B is a perspective view of a bottom side of the retention module of FIG. 1A.

FIG. 1C is a perspective view of a portion of a printed circuit having alignment features over a surface in accordance with an example embodiment.

FIG. 1D is a cross-sectional view of the retention module and printed circuit board of FIG. 1A taken along the line 1D-1D.

FIG. 2 is a perspective view of a probe assembly adapted to engage the retention modules of example embodiments.

FIG. 3A is a top-view of a portion of a printed circuit board having a plurality of probe contacts and alignment features in accordance with an example embodiment.

FIG. 3B is a cut-away view of a first end of a retention module disposed over a circuit board in accordance with an example embodiment.

FIG. 3C is cut-away view of a second end of a retention module disposed over a circuit board in accordance with an example embodiment.

FIG. 4 is a cutaway view of alignment features of an example embodiment during fabrication.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

The example embodiments described in detail herein relate to a surface mount retention module for a probe assembly and the alignment of the retention module to a printed circuit board. However, the use of the alignment features described in connection with the example embodiments is not limited only to probe assembly retention modules. For example, the alignment features may be adapted for use with retention modules in electrical connector applications. In such embodiments, the retention modules may be a surface mount mating half of an electrical connector that is disposed over a circuit board or similar structure.

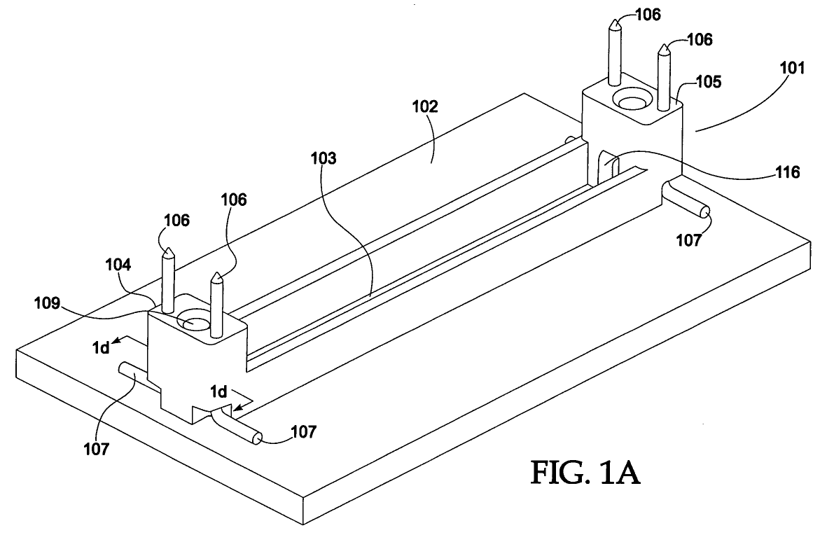

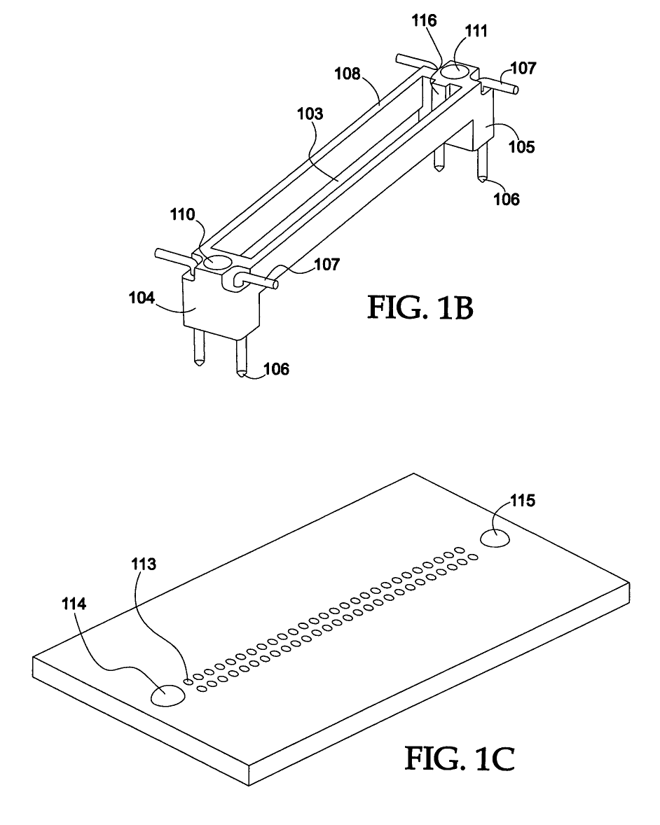

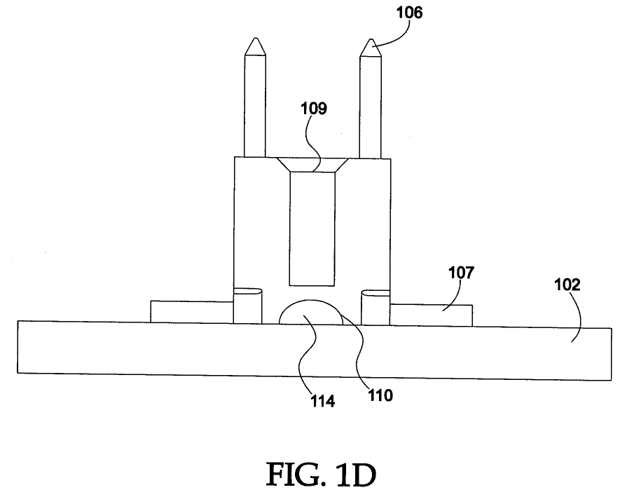

FIG. 1A is a retention module 101 disposed over a printed circuit board 102 in accordance with an example embodiment. In a specific embodiment, the printed circuit board 102 is a circuit board of a target (also referred to herein as a target board). The board 102 may be a known multi-level circuit board, with circuits at electrically isolated levels and level-to-level interconnections as needed. Such circuit boards are known to one of ordinary skill in the art, and are not described in significant detail to avoid obscuring the description of the example embodiments.

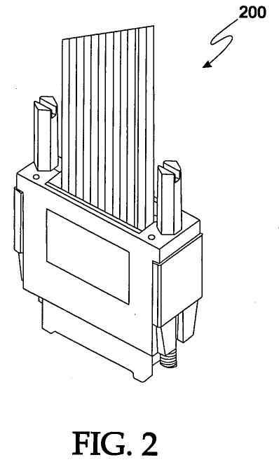

The retention module 101 includes an opening 103, which is adapted to receive a probe assembly therein. The interface between the probe and the target board is connectorless. An illustrative probe assembly 200 is shown in FIG. 2. The probe assembly 200 is described in U.S. Pat. No. 6,822,466 to Holcombe, et al. and assigned to the present assignee. The disclosure of this patent is specifically incorporated herein by reference.

The retention module 101 includes a threaded opening 109 at a first end 104 and a second end 105. The openings 109 are adapted to receive retention screws or other fasteners that secure the probe assembly 200 to the retention module 101. In addition, the retention module 101 includes alignment pins 106 in a rectangular arrangement. The alignment pins 106 are adapted to engage openings (not shown) on the probe assembly 200 to ensure the proper alignment of the probe assembly to the retention module 101. Depending on their orientation, the alignment pins 106 can provide a polarizing feature to ensure that the probes of the probe assembly are aligned properly to engage respective contacts on the target board 102. In addition, the retention module 101 may include a polarizing feature 116 within the opening 103 to ensure probe/contact alignment. Further details of the alignment between the retention module 101 and the probe assembly 200 may be found in the patent to Holcombe, et al.

Each alignment pin 106 has an end 107 that is disposed over a surface of the circuit. The ends 107 provide surface mounting of the retention module 102 and fastening of the module 101 to the board 102. In particular, after the retention module 101 is disposed over the board 102, the ends 107 are secured to the board 102 using solder (not shown) or a suitable adhesive material (not shown), such as epoxy. In this manner, the retention module 101 is surface mounted and secured to the circuit board 102.

FIG. 1B shows the retention module 101 with a bottom surface 108 facing up. The retention module 101 includes a first alignment feature 110 on the first end 104 and a second alignment feature 111 on the second end 105. As detailed herein, the alignment features 110, 111 are complementary to respective alignment features disposed on the target board 102. As such, the first alignment feature 110 and the second alignment feature 111 are also referred to herein as the first complementary alignment feature 110 and the second complementary alignment feature 111.

In a specific embodiment, the retention module 101 is a molded by known techniques from a suitable material, such as plastic. The complementary alignment features 110, 111 are formed as recesses in the retention module 101 in this molding process. Regardless of the fabrication method or material used for the retention module, the first and second complementary alignment features 110 and 111, respectively, are accurately located to within approximately +/−0.005″. This tolerance range is well within the standard processing tolerances molded plastic parts.

FIG. 1C is a perspective view of a portion of the target board 102 where the retention module 103 will be located and where the probe assembly engages the target board. The board includes a plurality of contacts 113 in a footprint that substantially matches the footprint of the probes of the probe assembly. In a specific embodiment, the interconnect between the probe assembly is a surface-mount configuration. In such an embodiment, the contacts 113 are conductive pads, which are connected to circuit traces (not shown) on the board. In another specific embodiment, the contacts 113 are conductive openings in the target board 102. In such an embodiment, the probes are inserted into respective contacts 113, which are connected to circuit traces.

FIG. 1C shows a first alignment feature 114 and a second alignment feature 115 disposed over the surface of the target board 102. In the present embodiment, the first alignment feature 114 is disposed at a one end of the contacts 113 and is adapted to engage the first complementary alignment feature 110 at the first end 104 of the retention module 101; and the second alignment feature 115 is disposed at the other end of the contacts 113 and is adapted to engage the second complementary alignment feature 111 at the second end 105 of the retention module 101.

In a specific embodiment, the first and second alignment features 114 and 115, respectively, are substantially identical. Likewise in such an embodiment, the first and second complementary alignment features 110, 111, respectively, are substantially identical. As such, there is no polarizing provided by the alignment features 110, 111 or by the complementary alignment features 114, 115 to ensure proper orientation of the retention module 101.

In another specific embodiment, the proper orientation of the retention module 101 may be assured by providing polarization via the first alignment feature 110 and the first complementary alignment features 114, and via the second alignment feature 111 and the second complementary alignment feature 115. In particular, the first alignment feature 114 is of a first shape (e.g., a hemi-ellipsoid) and the first complementary alignment feature 110 is substantially the same shape (e.g., a hemi-ellipsoidal recess in the first end 104). Similarly, the second alignment feature 115 is of a second shape (e.g., a hemi-sphere) and the second complementary alignment feature 111 of substantially the same shape (e.g., a hemi-spherical recess). The polarization of the complementary alignment features 110, 111 of the target board 102 and the first and second alignment features 114,115 of the retention module ensure that the retention module 101 is disposed over the target board 102 in a desired orientation.

In a specific embodiment, the orientation of the probe assembly 200 is provided via the polarizing feature 116 in the retention module 101. Such a polarization feature is described in the patent to Holcombe, et al. The polarizing feature 116 in the retention module 101 engages a polarization opening (not shown) in the probe assembly 200, which ensures that the probes (not shown) of the probe assembly 200 engage respective (‘correct’) contacts 113 on the target board.

Regardless of the shape of the first alignment feature 114 and the second alignment feature 115, the tolerance of the location the features are well within the acceptable tolerances of printed circuit board fabrication. In a specific embodiment, the alignment features 114, 115 are accurately located on the target board 102 to within approximately +/−0.005″.

FIG. 1D shows the engagement of the retention module 101 with the target board 102 in an aligned manner via the alignment feature 114 with the complementary alignment feature 110 at the first end 104 of the retention module 101. Although not shown in FIG. 1D, similar alignment and engagement is carried out at the second end 105 of the board via the alignment feature 115 and complementary alignment feature 111.

The retention module 101 is lowered over the target board 102 with the complementary alignment feature 110 being disposed over the alignment feature 112. This ensures the suitable alignment of the retention module 101 over the board 102 so the probes of the probe assembly 200 are aligned with and thus connect to respective contacts 112 on the target board. In a specific embodiment, the retention module 101 is aligned to the board to within approximately +/−0.005″. This provides suitable alignment of the probe tips to the target pads/contacts. After the retention module 101 is properly located and aligned over the target board 102, the ends 107 of the alignment pins 106 are fastened to the board by soldering or epoxy.

As detailed in the example embodiments above, the alignment features 112 are the complement of alignment features 110 disposed over the board. Stated differently, the alignment features 112 and 110 are the ‘negative’ of one another. For example, in the example embodiment shown in FIGS. 1B-1D, the alignment feature 114 is a hemi-ellipsoid and the alignment feature is a hemi-sphere; and the complementary alignment features 110 and 111 are a hemi-ellipsoid recess and a hemi-spherical recess, respectively, in the retention module 101. Other alignment features may be used. Features of another example embodiment are presently described.

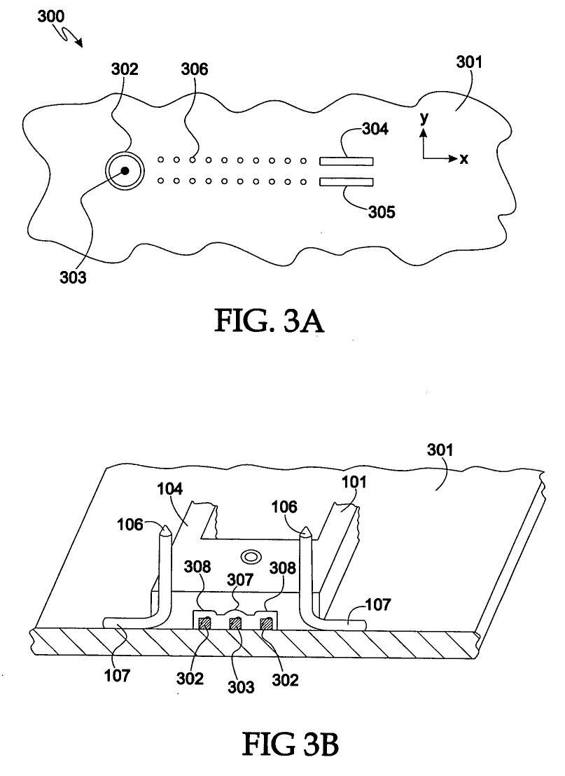

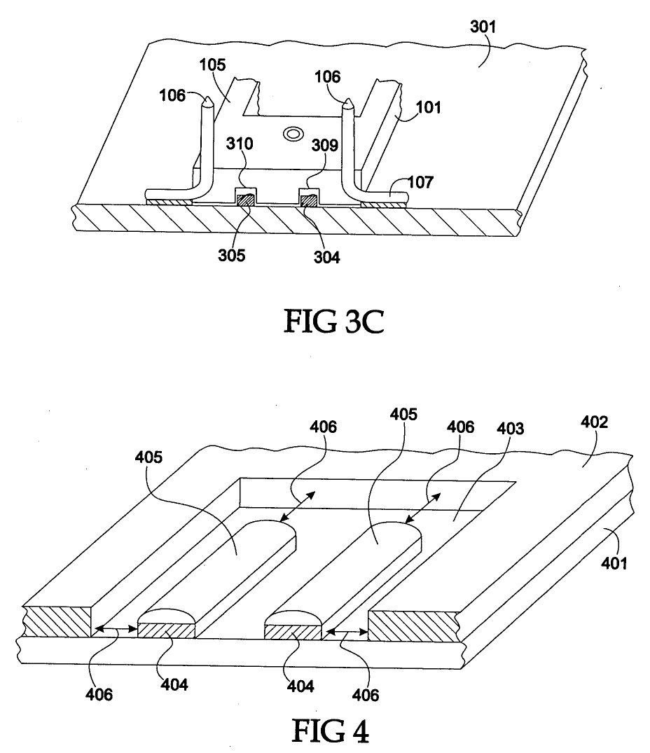

FIGS. 3A-3C relate to a retention module for a probe assembly in accordance with an example embodiment. Many of the details described in connection with the embodiments of FIGS. 1A-2 are common to the presently described embodiment and in the interest of clarity are not repeated.

FIG. 3A shows an interface 300 on a portion of a target board 301 in accordance with an example embodiment. The interface 300 includes first alignment features 302 and 303 at a first end of a plurality of contacts 306; and second alignment features 304 and 305 at a second end of the plurality of contacts 306. The first alignment features 302, 303 are adapted to engage complementary alignment features at a first end of a retention module (not shown in FIG. 3A); and second alignment features 304,305 are adapted to engage complementary alignment at a second end of the retention module (not shown in FIG. 3A). As can be appreciated, the first and second alignment features 302-305 provide polarization for the retention module. In addition, the first alignment features 302,303 provide alignment in the x-y plane and the second alignment features 304, 305 prevent rotational misalignment (e.g., about the z-axis of the coordinate system shown). The shapes of the first alignment features 302,303 and the second alignment features 304,305 are merely illustrative. Accordingly, these features may be of a wide variety of shapes, which provide alignment and, optionally, polarization of the retention module.

FIG. 3B is a cut-away view of a first end 104 of a retention module 101 disposed over the first alignment features 302, 303 in accordance with an example embodiment. The first end 104 of the retention module 101 has first complementary alignment features 307 and 308. The first complementary alignment features 307 and 308 are adapted to engage the first alignment features 302 and 303, respectively. In particular, the first complementary alignment feature 307 is a recess in the retention module 101 that is adapted to receive the first alignment feature 303; and the first complementary feature 308 is a recess in the module 101 that is adapted to receive first alignment feature 302.

FIG. 3C is a cutaway of the retention module 101 disposed over the second alignment features 304, 305. The second end 105 of the retention module 101 has second complementary alignment features 309 and 310. The second complementary alignment features 309 and 310 are adapted to engage the second alignment features 304 and 305, respectively. In particular, the second complementary alignment feature 309 is a recess in the retention module 101 that is adapted to receive the second alignment feature 304; and the second complementary feature 310 is a recess in the module 101 that is adapted to receive the second alignment feature 310.

The retention module 101 is disposed over the target board 301 with the first alignment features 302, 303 engaging the first complementary alignment features 307, 308 and the second alignment features 304,305 engaging the second complementary features 309,310. After the retention module 101 is properly seated, the ends 107 of alignment pins 106 are fastened to the target board 301.

The various shapes of the alignment features and complementary alignment features provide polarization so that the first end 104 and the second end 105 of the retention module 101 are properly located. The proper location and orientation of the retention module 101 ultimately ensures that the probes of the probe assembly 200 properly engage respective contacts 306 on the target board 301. As noted previously, the proper engagement of the probe assembly to the retention module 101 may be fostered using a polarization element(s) (e.g., polarizing feature 116) within the retention module and as described in the patent to Holcombe, et al.

The retention modules and alignment features described in the example embodiments provide many benefits. For example, the retention module 101 is disposed in a self-aligned manner over the target board. Accordingly, the probe assembly 200 engages the contacts of the target board accurately. Furthermore, the retention module is surface mounted over the target board. As such, the inter-layer circuitry of the multi-layer target board is not interrupted by through-board fasteners or the holes in which the fasteners are received. Finally, there are clear benefits to the manufacture of alignment features of the target boards of the example embodiments. Some of these benefits are described in conjunction with a process for fabricating the alignment features over the target board described presently.

FIG. 4 is a partial cross-sectional view of a portion of a target board 401 during processing. A solder mask 402 is selectively disposed over a surface 403 of the board 401. Traces 404 are also disposed over the surface 404. The traces 404 are formed by known printed board processing methods such as etching or milling. The traces 404 are formed in a like manner to circuit traces or transmission lines that are formed on the surface 403 of the target board and thus may be formed without additional processing steps during board processing. In a specific embodiment, the traces 404 are copper. However, the traces 404 may be of other materials to which solder will adhere and which are suitable for circuit traces.

After the solder mask 402 is formed, a solder paste is screened over the solder mask 402, the surface 403 and the traces 404. In a specific embodiment, the solder paste is a known material and is applied by a known method. Thereafter, a known solder reflow step is carried out. The solder reflow may be used, for example, to solder components (not shown) to the target board 401. In addition to soldering the components to the target board 401, the reflow sequence causes the powder particles in the solder to wet the surfaces of the traces 404. This solidifies the solder to create a metallurgical bond between the traces 404 and solder bumps 405 formed over the traces 405. The traces 404 and solder bumps 405 form the alignment features (e.g., second alignment features 304, 305) over the target board. Like the forming of the traces 404, the forming of the solder bumps may be formed during board processing, and thus does not require additional processing.

In a specific embodiment, suitable alignment with complementary alignment features on the retention module is realized by providing alignment features (e.g., alignment features 302-305) having a height from the surface of the target board between approximately 0.010″ and approximately 0.020″. The height of the feature can be varied by varying the size of the pad on the board. When the solder melts, the surface tension forms an arcuate shape. The height of the arc is proportional to the diameter/width of the trace 404. Tailoring the height of the solder bumps 405 to provide sufficient height for the alignment features may be carried out using various known printed circuit board processing techniques. Two illustrative methods are described presently.

In one embodiment, a space 406 is provided between the end of the solder mask 402 and the traces 404. Solder paste is screened onto the traces 404, forming a relatively flat layer of solder paste over the traces 404. During reflow, the solder from the solder paste will not adhere to the surface 403 or to the solder mask 402. However, the solder will adhere to the traces 404. The traces 404 have a width and a length that is chosen to provide suitable dimensions for the alignment features. Moreover, the width/diameter of the traces 404 is chosen to provide a suitable height for the alignment features.

In another embodiment, the spacing 406 is substantially eliminated and the traces 404 are mask-defined. The solder paste is then applied over a larger area that includes the solder mask 402 and the traces 404. During reflow, the solder will adhere to the traces 404, but not to the solder mask. Also, some of the solder paste on the solder mask 402 near the traces 404 will be drawn to and adhere to the traces 404, thereby providing additional height to the solder bumps 405

In the example embodiments, the height of the alignment features may be tailored by changing pad size, or using mask defined traces, or both. Beneficially, the alignment features comprising traces 404 and solder bumps 405 may be fabricated over the target board 401 during required processing of the board 401. Accordingly, additional processing is not required to realize the alignment features.

In accordance with illustrative embodiments described, a probe and probe assembly testing device are adapted to provide signals to test equipment with improved parasitic loading. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

1. An interface for a surface mount connection, comprising:
a retention module;
a circuit board having at least two alignment features disposed over a surface of the circuit board, wherein the at least two alignment features are solder alignment features; and
complementary alignment features on the retention module, wherein each of the complementary alignment features is adapted to receive a respective one of the at least two alignment features.

2. (canceled)

3. An interface recited in claim 1, wherein the at least two alignment features further comprise a first alignment feature disposed at a first end and a second alignment feature disposed at a second end.

4. An interface as recited in claim 3, wherein the retention module includes a first end and a second end and the complementary alignment features further comprise:
a first complementary alignment feature disposed at the first end and adapted to receive the first alignment feature; and
a second complementary alignment feature disposed at the second end and adapted to receive the second alignment feature.

5. An interface as recited in claim 4, wherein the first and second complementary alignment features and the first and second alignment features are polarized features.

6. An interface as recited in claim 4, wherein the first and second complementary alignment features and the first and second alignment features are not polarized features.

7. An interface as recited in claim 1, wherein the at least two alignment features further comprise a plurality of first alignment features and a plurality of second alignment features.

8. An interface recited in claim 7, wherein the retention module includes a first end and a
second end and the complementary alignment features further comprise:
a plurality of first complementary alignment features disposed at the first end of the retention module and adapted to receive respective alignment features of the plurality of first alignment features; and
a plurality of second complementary alignment features disposed at the second end of the retention module and adapted to receive respective alignment features of the second alignment features.

9. An interface as recited in claim 1, wherein the retention module further comprises a plurality of retention pins.

10. An interface as recited in claim 1, further comprising a probe assembly having probes that are adapted to engage contacts on the circuit board.

11. An interface as recited in claim 1, wherein the retention module is a surface mount retention module.

12. An interface as recited in claim 9, wherein the plurality of retention pins are surface mounted to the circuit board.

13. A retention module, comprising:
an upper surface and a lower surface;
a first end and a second end; and
at least two alignment features disposed over the lower surface, wherein the alignment features are adapted to receive respective solder alignment features of an engagement surface.

14. (canceled)

15. A retention module as recited in claim 13, wherein the at least two features further comprise a first alignment feature disposed at the first end and a second alignment feature disposed at the second end.

16. A retention module as recited in claim 13, wherein the at least two alignment features further comprise a plurality of first alignment features disposed at the first end and a plurality of second alignment features disposed at the second end.

17. A retention module as recited in claim 13, wherein the at least two alignment features are recesses in the lower surface of the retention module.

18. A retention module as recited in claim 13, wherein the at least two alignment features are polarized.

19. A retention module as recited in claim 15, wherein the at least two alignment features are not polarized.

20. A retention module as recited in claim 13, wherein the retention module is adapted to be surface mounted.
